(19) United States
(12) Patent Application Publication
(10) Pub. No.: US 2019/0178064 A1
(43) Pub. Date: Jun. 13, 2019

(54) GAS LIFT ACCELERATOR TOOL

(71) Applicant: Oil & Gas Tech Enterprises C.V., Noordwijk (NL)

(72) Inventors: Scott Vander Velde, Calgary, CA (US); Helimenas Dominguez, Ciudad Ojeda (VE); Abdon Aranguren, Ciudad Ojeda (VE)

(21) Appl. No.: 16/219,733

(22) Filed: Dec. 13, 2018

Related U.S. Application Data
(60) Provisional application No. 62/598,275, filed on Dec. 13, 2017.

(51) Int. Cl. E21B 43/12; F04F 5/46; G01F 1/44; G01F 1/36

(52) U.S. Cl. CPC E21B 43/123; E21B 43/124; G01F 1/363; F04F 5/464; G01F 1/44; E21B 43/126

(57) ABSTRACT

The gas lift accelerator is a method and a downhole apparatus based on the principle of the jet pump to allow the extraction of reservoir fluids up to high API grade with low or no reservoir pressure, at any depth, by injecting available gas in the oil field, allowing the flexibility of operation on diverse well completion configurations like sliding sleeve type and gas lift mandrels, complementing the operating when other methods like traditional gas lift procedures or hydraulic fluid jet pumps are not effective. The gas lift method includes the use of downhole and surface metering data to optimize the operation of the gas lift accelerator apparatus.

The present application claims priority to U.S. Application No. 62/598,275 filed on Dec. 13, 2017, the entire contents of this application being incorporated herein by reference.

### FIELD OF THE INVENTION

The present disclosure provides a method and apparatus used for the extraction of oil/gas fluids from reservoirs.

### BACKGROUND

There are different technologies utilized to artificially lift oil in an oil well, including the use of steam, diesel fuel, acids, surfactants, mechanical pumps and/or plungers.

The use of jet pumps in the oil industry is known, with some known devices being fixed devices installed as a part of the completion hardware and requiring considerable downtime during installation and removal. More recently easy to install and remove jet pumps operated with hydraulic fluids have been developed, which solve the downtime of its predecessors but have limitations because of the interaction with other primary recovery methods based on the use of gas for the artificial lift of the oil, and even more, they are restricted to operate in shallow (above 10.000 ft) depths because of the limitations on the pumping of the power hydraulic fluid from the surface.

Actual hydraulic fluid jet pumps are used mainly as a secondary recovery method employed after some other primary recovery method, such as gas lift, have been used and becomes ineffective. The gas lift technique requires the installation of calibrated gas lift valves at specific depths, in specific ports of the tube element called gas lift mandrels, and serve to control the flow of the injected gas from the annular space formed between the case and the production tubing into the inner side of the production tubing, where the low pressure reservoir fluid column is confined. The installation of these valves must be precise and operational failures and equipment damage may occur if those valves are misplaced during installation, thereby reducing the reliability and increasing the operational costs of the well.

### SUMMARY

The present invention relates to a gas lift accelerator (GLA) which in selected embodiments can use is a pump powered by injected natural gas from the surface. Injected natural gas, for example, which supplies the energy required to pump the reservoir fluid and thereby cause it flow up to the surface, can be implemented by taking advantage of the Venturi effect. A preferred embodiment can use a submersible jet pump to transport the fluid.

The Venturi effect states that a moving fluid inside a closed pipeline decreases its pressure in zones where speed of the fluid increases. According to this effect, when a fluid moves through a pipeline where different cross-sectional area values are involved, it experiences a change in both its potential and kinetic energy values. When the fluid flows through a constricted section of a pipe, its pressure is reduced and its speed is increased over the smaller cross-area regions, due to the involved potential to kinetic energy transformations. Studies of the Venturi effect have enabled the fabrication of appliances where the speed of the fluid at Mach number values approximately equal to one have been achieved.

The present invention considers a continuous flow of oil, which is similar to the natural (i.e. without artificial lift methods involved in the process) production method, with the difference that gas-liquid proportion is affected in the fluid column by injection of compressed gas into the well. This gas injection produces a change in the oil column density, allowing that the pressure gradient inside the well to be great enough to produce a force that brings the oil to the wellhead. It is to inject the gas as deep as possible into the well to be able to produce the desired change in oil column density and, to inject the right amount of gas that produces a liquid-gas mixture where the multi-phase friction involved does not cancel or affect the desired weight reduction inside the oil production pipeline. Additionally, in order to optimize the gas distribution between wells of the same system, it is preferred to use models that allow recovery of as much oil as possible, considering that the water content in the well is a factor which method's rentatibity, because water is, normally, heavier than oil and will not dissolve gas within to assist in the decrease of the oil column density inside the production tubing.

In an oil production system, energy loss (pressure drops in the pipeline's accessories and in pipelines) depends on the properties of the involved fluids and, specifically, on the production flow rate. The system's production capability responds to a balance between the wells' potential to give in energy and the energy demands of the whole installation.

The sum of all the energy losses (pressure drops) in each pipeline components is equal to the global energy loss. This is the difference between the inlet pressure value of the oil in the reservoir, Pws, and the final pressure value, Psep:

Pws−Psep=ΔPy+ΔPc+ΔPp+ΔPI

where:
ΔPy=Pws−Pwfs, which corresponds to a pressure drop in the oil reservoir, (IPR),
Δ Pc=Pwfs−Pwf, which corresponds to a pressure drop in the completion (Jones, Blount & Glaze);
ΔPp=Pwf−Pwh, which corresponds to a pressure drop in the well, (FMT-vertical).
ΔPI=Pwh−Psep, which corresponds to a pressure Drop in flow line. (FMT-horizontal).

Note that Pwfs is the pressure at the bottom of the well at the interface between the well core casing and the reservoir. Note further that IPR refers to the inflow performance relationship and can be represented by a drive of the available energy of the well or a function of pressure and flowrate that can be used to simulate the pumping of oil through a pipeline. This can comprise the pump quadratic characterization curve or function. The vertical lift performance (VLP) can be defined by a function of pressure and flowrate for the well where the VLP can comprise a pipeline loss quadrate curve. FMT related to field measurements of pressure with a tool.

Traditionally, the energy balances of the system (between reservoir, well and separator) are generally referred to as being at the bottom of the well as an intermediate node. However, the current availability of simulators of the oil production process allows setting of the energy balance in different places (i.e. nodes), along the pathline of the production process (e.g. wellhead, separator, etc.).

In order to make the energy balance in a selected node, several flow rates can be utilized then, for every one of the useable nodes, the flow rates are determined both for the pressure at which the reservoir delivers the selected flow rate to the node inlet and the required pressure at the outlet of the node to transport and to deliver that selected flow rate at the separator, with a remnant pressure equal to Psep.

For example, if the node is at the bottom of the well:

Inlet pressure of the node: Pwf(offer)=Pws−ΔPy−ΔPc
Outlet pressure of the node: Pwf(demand)=Psep+ΔPI+ΔPp

On the other hand, if the node is in the wellhead:

Inlet pressure of the node: Pwh(offer)=Pws−ΔPy−ΔPc−ΔPp
Outlet pressure of the node: Pwh(demand)=Psep+ΔPI The graphical representation of inlet pressure values of the fluids in the node as a function of the flow rate or production rate is called the energy supply curve or reservoir fluids curve (Inflow Curve), and, the graphical representation of the required pressure at the exit (outlet) of the node as a function of the production rate is called the energy demand curve or installation fluids curve (Outflow Curve). If the well bottom is chosen as the node, the supply curve is the “IPR” and the demand curve is the “VLP”.

The present disclosure provides a method and a downhole apparatus based on the principle of the jet pump to allow the extraction of reservoir fluids up to high American Petroleum Institute (API) grade with low or no reservoir pressure, at any depth, by injecting available gas in the oil field, allowing the flexibility of operation on diverse well completion configurations like sliding sleeve type and gas lift mandrels, complementing operation when other methods, like traditional gas lift procedures or hydraulic fluid jet pumps, may not be effective. The method may include the use of measured downhole and surface metering data to improve operation. The system can use, for example, a grade in the range of API10 up to API22 for extra heavy, heavy weight and medium weight crude oil.

Exemplary embodiments disclosed herein may provide a method and a down hole apparatus that are based on the known principle of the jet pump powered by pressurized gas injected through the annular space between the production tubing and the case in a completed oil/gas well, to the flow of a reservoir fluid wherein the pressure is not enough to overcome the hydrostatic column of fluid up to the surface.

Applications of the invention relate to proven technologies and techniques for removal of fluids otherwise unable to flow to surface due to low reservoir pressures or well fluids of high viscosity or solids content.

Exemplary embodiments disclosed herein may provide:
1) A simple and effective method using proven technology to assist the extraction of well fluids of high viscosity or solids content, for oil fields with availability of natural gas resources.
2) Improved reliability of the well production during gas lifting operations, avoiding misplacement of the installed elements and valves, minimizing damage of those components and avoiding unnecessary gas recirculation up to the surface.
3) A method to control at the surface the gas injected into the well to power the bottom hole gas lift accelerator (GLA) jet pump, depending on the data received and processed from the downhole formation fluid, for a single oil/gas well or in a plurality of wells sharing the same surface pressurized gas source.
4) A method capable of diagnosing the GLA bottom hole components status.
5) A secondary recovery method compatible with the completion hardware and the production tube elements used in gas lift operations, with flexibility to be precisely set at the different depths where the gas lift mandrels and control valves are already in place (i.e. at the depth of the producing reservoirs).
6) A recovery method for sands or producing formations located at high depths where actual hydraulic fluid powered jet pumps are not capable of operating.
7) Allowing the same apparatus to be installed in completed wells with either sliding sleeves (circulation sleeves) or gas lift mandrels without requiring retrieval or replacement of the completion elements of the well.
8) The possibility of using the GLA to supply certain functionalities such as a gas lift control valve.
9) Reduced downtimes and operational costs of the production oil/gas well, because of the simple to install and remove setting mechanism and robustness and durability of the components.

An exemplary embodiment of a gas lift acceleration apparatus disclosed herein may include a GLA lock mandrel, a jet pump, a backflow restraining element at the injection nozzle conduit, a nozzle injector, an inlet conduit and a mandrel housing which contains a Venturi throat and diffuser, with an upper and lower sealing element to allow the interface with exchangeable interface elements. The exchangeable interface elements may be, for instance, fish neck retrieval subs when the apparatus is configured to be installed on a gas lift mandrel or the interface elements can be tubing anchor locks when the apparatus is configured to be installed at a fixed location in production tubing. Another element of the GLA apparatus is a lower nipple or marker location containing the sensors for temperature and pressure metering of the formation fluid at the entrance of the Venturi, with its corresponding communication system, to convey the signal up to a surface data acquisition and processing system. For the operation of the GLA apparatus, in some exemplary embodiments, the well may be completed, with packers delimiting the producing sands and thereby avoiding formation fluid from entering the annular space between casing and production tube. Surface equipment may be used to pressurize and inject the gas into the well, and recovery equipment may be used to separate the obtained mixed fluid gas/oil in order to recirculate partially the recovered gas into the system. That surface equipment or device (excluding the data acquisition and processing devices) may be the same used for gas lift operation, and in some cases may be already present at the well surface

The data acquisition nipple may be utilized in some exemplary embodiments, but alternative exemplary embodiments of the GLA apparatus may not have this nipple.

The possibility of using different interface elements makes possible the same GLA apparatus to be installable either as a fixed element on the completed production tubing (with a sliding sleeve), or being easily installed or removed into an existing gas lift mandrel already installed on the well by placing it into the well mainly by a wirelines connection, cable, slick lines or similar wire based well intervention operating methods, but not limited to other setting methods including those in operation on deviated or horizontal wells.

The restraining backflow element may, in some exemplary embodiments, be a check valve, which is provided to control the fluid flow action in which the invention operates. In one manner of operation, high pressure fluid provided from a surface pressurized fluid delivery device is passed through the check valve to the Venturi nozzle thereby forming the “vacuum” effect to help lift the well fluids into the energized stream. If the surface equipment is in need of repair or replacement and is stopped for any reason, the check valve prevents well fluid from escaping to the surface equipment if sufficient well fluid pressure is present.

The restraining backflow element of the GLA apparatus can be used in certain embodiments like a gas control valve, similar to the calibrated valves used in a gas lift, by calibrating the force of the opening element of the restraining backflow, which is a normally closed valve type element. As an example of this, in some embodiments of the GLA apparatus, the restraining backflow element is a check valve including a ball or other blocking element, a setting spring and a settlement housing. By selecting a determined spring constant to produce the spring bias or compression (valve opening threshold) at a selected gas pressure, it allows the passage of the injected gas only when its pressure is above the determined level, as in the case of a regular gas control valve.

The action of the pressurized gas injected through the jet pump of the GLA to actuate on the column of well fluid on the production tubing can be produced by three effects: a) the Venturi effect, which creates a pressure drop at the jet pump throat, producing a pressure differential that aids in generating the force needed to displace the fluid below the GLA up to the Venturi; b) the lightening of the fluid column weight because of the mixture of the reservoir fluid with the injected gas because of the lower density of the gas with respect to the oil, decreasing the pressure required to overcome the hydrostatic column up to the surface; and c) increasing the pressure of the oil/gas mixture at the GLA jet pump diffuser providing the pressure to overcome the mixture in the hydrostatic column.

The disclosed apparatus may be used in producing wells when the reservoir fluid level is over the position of the jet pump throat, but can also be used when the reservoir level is below that level by modifying the conditions of the injected power fluid and by adding some repository fluid through the production tubing to achieve the required level of the Venturi's throat.

Some exemplary embodiments of a method disclosed herein relate to the use of the signals from the bottom hole reservoir pressure and temperature sensors and the data received from the surface pumped mixture from a single well, or from a plurality of oil/gas wells, in order to control the injection of the pressurized gas from a surface pressurized gas source. The method also may include using the GLA jet pump functionality of the apparatus and the capability of diagnosing its operative status by processing bottom hole and surface data. The diagnosis can indicate malfunctioning or damage of the GLA apparatus.

Exemplary embodiments can utilize materials specifically selected to provide longevity against damage and wearing incurred by obstructive materials from the wellbore such as H₂S and sand. In some exemplary embodiments, some or all of the components are formed of metals or metal components carbon steel (4140 and 4340) with tungsten carbide and/or ceramic materials, for example. The body of the apparatus can be made robust enough to avoid damage because of impact with other elements by manipulation, installation or retrieval.

### BRIEF DESCRIPTION OF THE DRAWINGS

FIG. 1a is a schematic section view of a producing oil/gas well with a gas lift accelerator tool installed, during operation.

FIG. 1b illustrates the Venturi effect having a constriction or choke in a reduced diameter region of the tube.

FIG. 1c illustrates the functional relationship for vertical lift performance and inflow performance and optimal sensor measurement positions in the well.

FIG. 2a is a partial view of a longitudinal cross section of an embodiment of the gas lift accelerator tool installed on a producing oil/gas well during operation, showing arrow for the power fluid, reservoir fluid and mixture pumped to surface

FIG. 2b is a detailed view of a section from FIG. 2a showing an exemplary embodiment of the gas lift accelerator assembly indicating the fluid flows during operation.

FIG. 3 is a longitudinal cross section through an exemplary embodiment of a tool equipped with a lock mandrel for installation into wells equipped with landing nipples when not installed in well.

FIG. 4 is a longitudinal cross section through an exemplary embodiment of a tool equipped with internal fishneck retrieval sub and top and bottom anchor locks for installation into wells equipped with gas pocket mandrels when not installed in a well.

FIG. 5 is a longitudinal cross section through the tool shown in FIG. 3 equipped with lock mandrel for installation into wells equipped with landing nipples, installed in well during operation.

FIG. 6 is a longitudinal cross section through the tool shown in FIG. 4 equipped with internal fishneck retrieval sub and top and bottom anchor locks for installation into wells equipped with gas pocket mandrels, installed in well during operation.

FIG. 7a to FIG. 7d is a sequence of an exemplary embodiment of a method of installation of the gas lift accelerator assembly configured for wells with gas pocket mandrels shown in FIG. 4 using a GO and GS style running tool.

FIG. 8a is a detailed longitudinal section view of an embodiment of a back flow restraining element of the gas lift accelerator tool showing the restraining element in open position allowing the flow of the power fluid injected into the gas lift accelerator tool.

FIG. 8b is a detailed longitudinal section view of an embodiment of the back flow restraining element of the gas lift accelerator tool showing the restraining element in normally closed position preventing the flow of the reservoir fluid into the annular

FIG. 9 is a schematic sectional view of a plurality of wells with gas lift accelerator assemblies installed into each of them, with reservoir fluid sensors located in a sensors nipple at the bottom of the GLA assembly.

FIG. 10a is a flow chart illustrating an exemplary embodiment of a method for operating an oil/gas well.

FIG. 10b is a flow chart depicting the processing and control of a plurality of wells.

### DETAILED DESCRIPTION

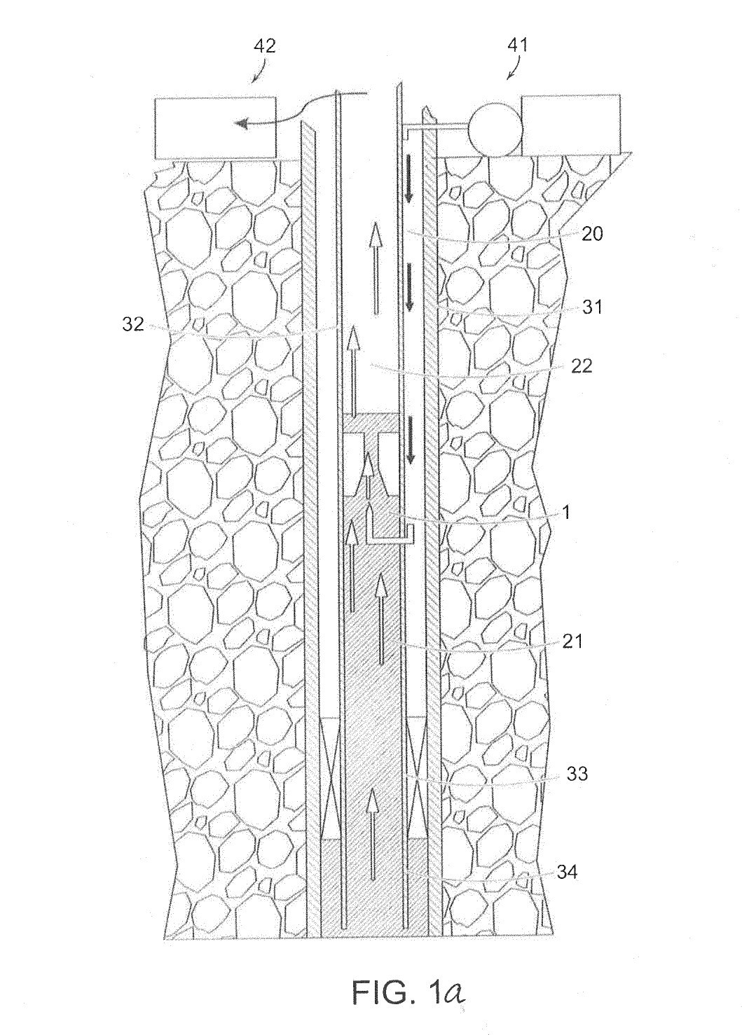

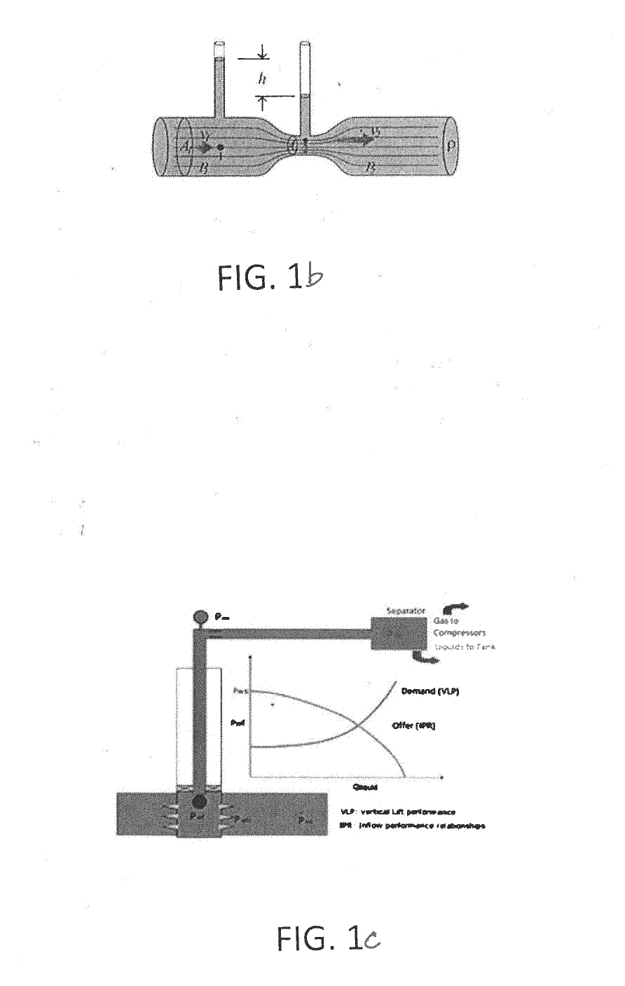

FIG. 1a is a schematic representation of the gas lift accelerator device (1) installed down hole in oil/gas wells, above a producing reservoir isolated with the packer (33) receiving pressurized gas (20) pumped from the surface compressors (41) through the annular space formed between the well casing (31) and the production tubing (32). The pressurized gas passes though the Venturi jet pump in (1) and mixes with the low pressure formation fluid (21) inside the production tubing, allowing the gas-formation fluid mixture (22) to flow up to the surface, where a separation device (42) can separate the gas from the pumped mixture.

FIG. 1b illustrates the Venturi effect where A₁ is the cross-sectional area of flow below the narrow passage of the Venturi throat with corresponding velocity v₁ and pressure p₁ values, A₂ showing the cross-sectional area within the constriction that can be indicated by the change in height h, and finally the increased velocity v₂ and pressure value p₂ above the constriction.

FIG. 1c shows an exemplary functional relationship for the IPR and VLP described herein

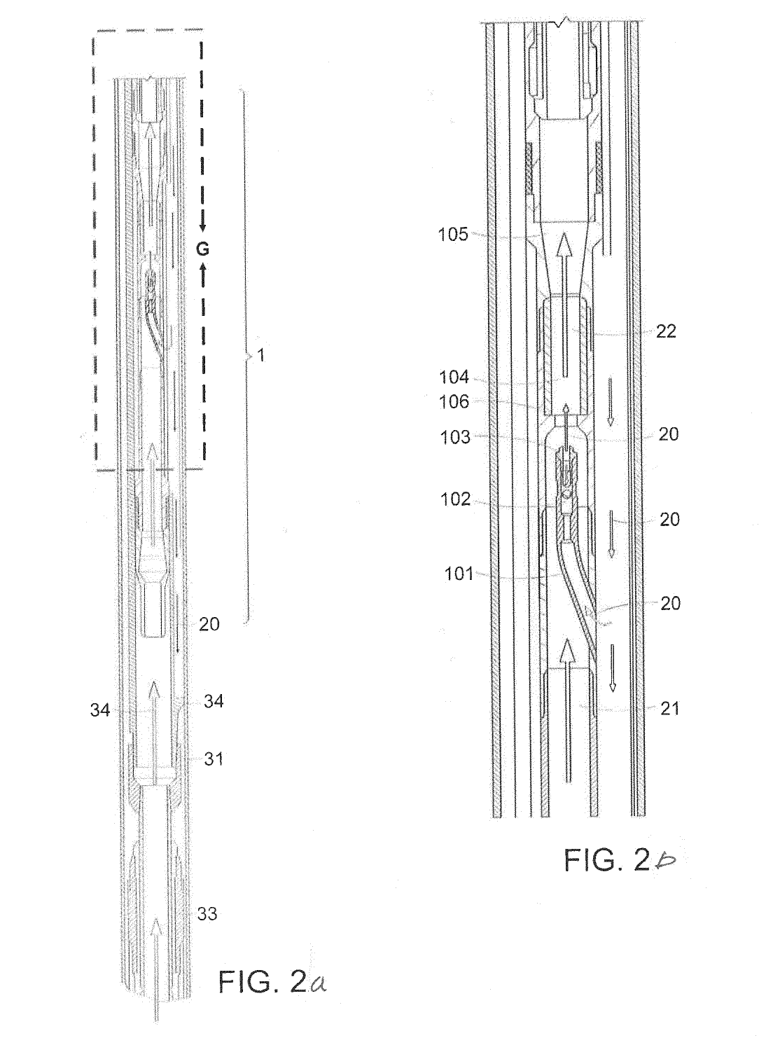

FIG. 2a shows a partial view of a longitudinal section view of an embodiment of the present gas lift accelerator device installed on a producing well, where the gas lift acceleration assembly (1) is located on a general gas pocket mandrel (34) as the ones installed for traditional gas lift operations, already installed on the well for previous gas lift recovery, with the arrow (21) representing the reservoir fluid flowing to the surface direction, the arrows (20) representing the gas injected down to the gas lift acceleration device from surface equipment, such as the fluids isolated by the packer (33) already installed on the producing well.

FIG. 2b is a detailed view of a portion of FIG. 2a showing some of the gas lift accelerator assembly components including the gas inlet conduit (101) which allows the entrance of the pressurized gas (20) from the annular into the internal area of the jet pump nozzle (103) where the gas (20) is accelerated to supersonic speed producing a drop of pressure that makes the reservoir fluid (21) flow up to the Venturi throat (106) where the gas (20) and the reservoir fluid (21) create a mixture (22) in the transition zone (104), which increase its pressure at the Venturi diffuser (105) resulting in a fluid with higher pressure and lower density than the original reservoir fluid, which allows it to overcome the hydrostatic column and flow up to the well surface.

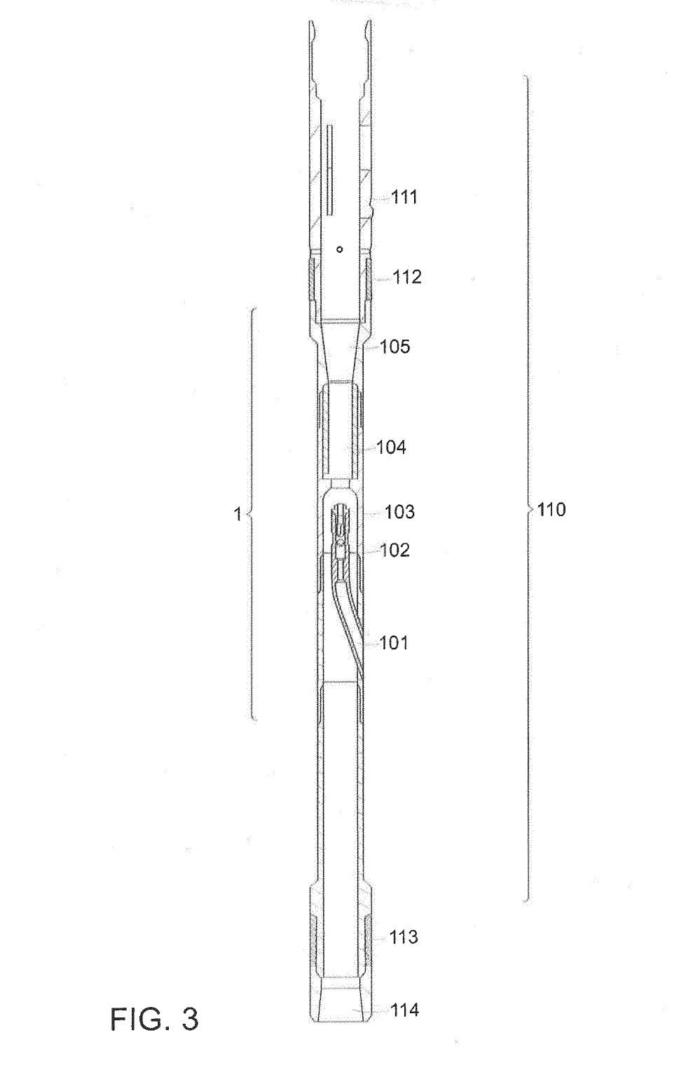

FIG. 3 is an embodiment of a gas lift accelerator assembly (1) configured for an installation into oil/gas wells where a landing nipple is installed in the production tubing. In this embodiment, the gas lift acceleration assembly (1) is assembled into a lock mandrel installation configuration (110) where a lock mandrel (111) can be installed into the landing nipple. The device is equipped with upper sealing element (112) and lower sealing elements (113). The injection fluid enters the device via inlet tube (114). The check valve (102) prevents well fluid from flowing to surface equipment when the device is operating. Replaceable Venturi jet nozzle (103) provides high velocity fluid energy to enter the Venturi. Venturi throat (104) provides a mixing area for injection and well fluids. Venturi diffuser (105) converts high velocity/low pressure fluid energy to low velocity/high pressure fluid energy. Well fluid enters the tool at the inlet sub (11).

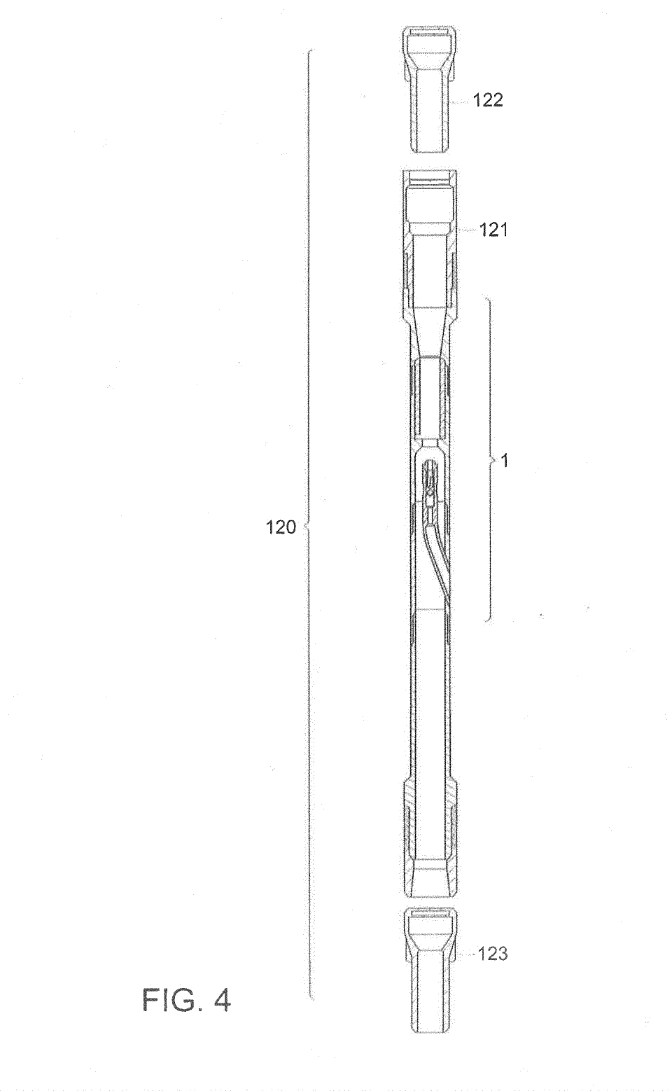

FIG. 4 is an embodiment of a gas lift accelerator assembly (1) configured for an installation into oil/gas wells where a gas pocket mandrel for gas lift operations is installed in the production tubing. The embodiment of the gas lift acceleration assembly (1) shown in FIG. 4 is similar to the embodiment shown in FIG. 3 and is assembled into a gas pocket mandrel configuration (120) by adding an internal fishneck retrieval sub (121) an upper tubing anchor lock (122) and a lower tubing anchor lock (123) to the top and bottom sides of the device. As should be appreciated, this allows the use of the same device assembly (1) for different well completion configurations.

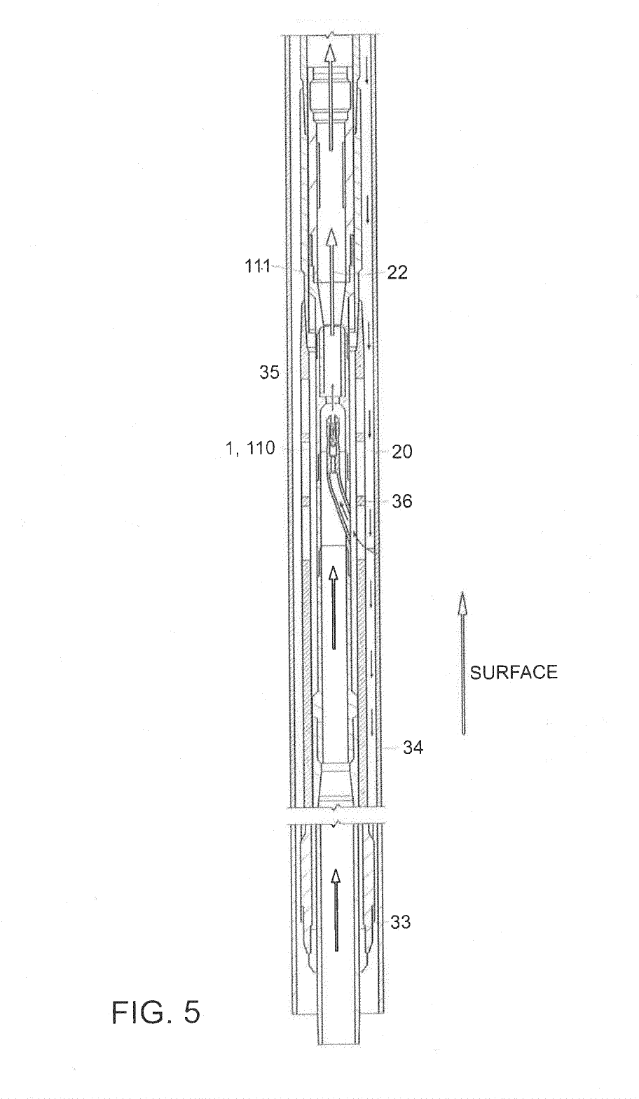

FIG. 5. shows an exemplary installation of the lock mandrel installation configuration assembly (110) shown in FIG. 3 into an oil well with a slotted production tubing or sliding sleeve tubing element (35), which allows the pass of the pressurized gas (20) into the gas lift acceleration device (1). The gas is contained between the casing (34) and the casing packer (33) forcing the gas (20) to flow into the tool (1). The complete assembly is fixed to the production tubing by a locating nipple (36) which attaches the lock mandrel (111) creating a conduit for the mixture fluid (22) to flow towards the surface. The tool assembly (1, 110) can be sent downhole in different ways including wire lines, inside the production tubing, and its setting depth position is precise because it is conditioned by the locating nipple (36) or other marker installed on the production tubing.

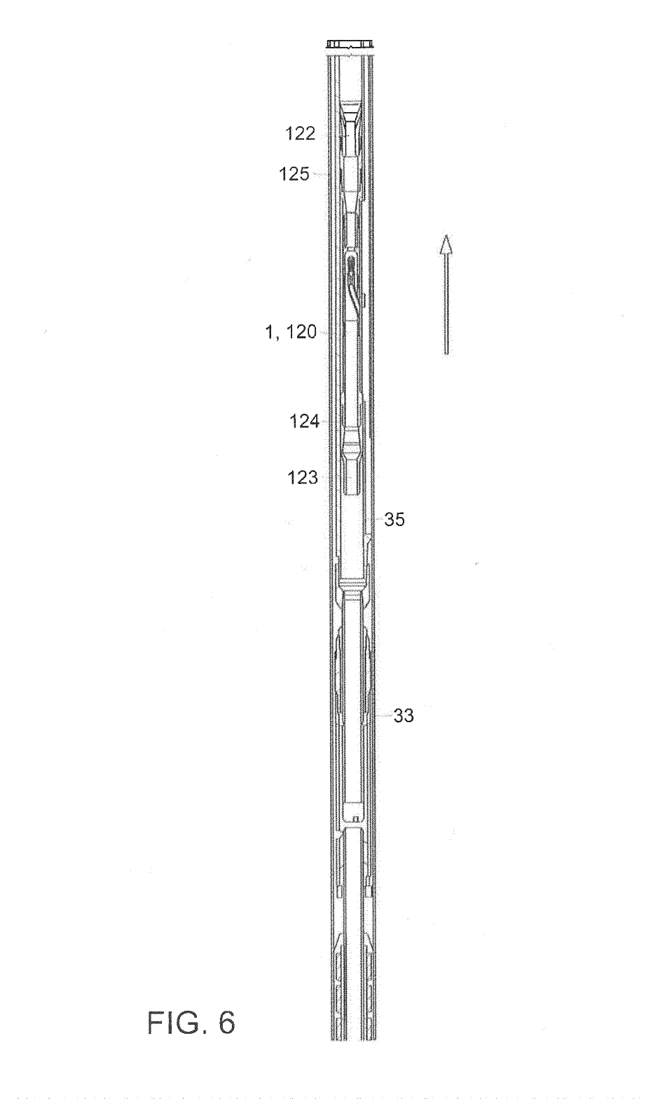

FIG. 6 shows an exemplary installation of the gas pocket installation configuration assembly (120) shown in FIG. 4 into an oil well with gas pocket mandrels (35) for gas lift recovery. The pressurized gas is constrained by the casing and the packer (33), and enters from the annular area into the gas lift accelerator through the pockets of the gas lift mandrel, with or without valves installed, to create the Venturi effect and produce the flow of the gas/oil mixture up to the surface. There are upper and lower seals (125) and (124) to seal the conduit from the suction of the tool (1) with the fluid inlet of the reservoir fluid. The tool can be precisely located by the upper tubing anchor lock (122) and the lower tubing anchor lock (123), making the pockets of the gas lift mandrel be coincident with the inlet conduit (101) shown in FIG. 2b.

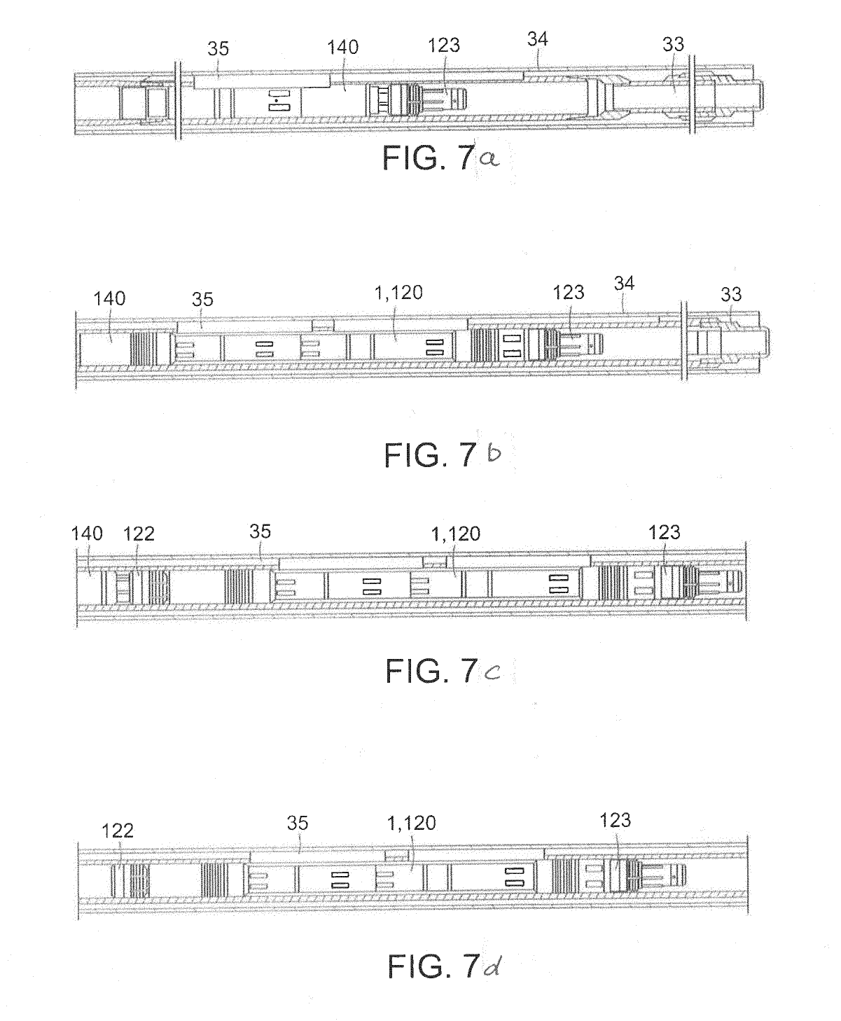

FIG. 7a, 7b, 7c and FIG. 7d illustrate an exemplary embodiment of a method for precisely locating the gas pocket installation configuration assembly (120) of the gas lift accelerator into a gas lift mandrel (35) installed on a well. In FIGS. 7a to 7d, the tool is not represented in a sectional view. The tools that may be used for setting of the tool assembly (120) can be a GO style running tool (140) and a GS style running tool (141). FIG. 7a shows the setting of the lower tubing anchor lock (123), which is driven by the GO style running tool (140) down to a specified depth by any depth correlation method, to be located at a specific position inside the gas lift mandrel (35), above the packer (33). The GO style running tool (140) is retrieved to surface. The gas lift accelerator assembly (1) is driven downhole by the GS style running tool (141), and attached to the previously installed lower tubing anchor lock (123) at an specific depth inside the gas lift mandrel (35), in order to be coincident with the opening of such gas lift mandrel (35), which allows the entrance of the power fluid from the annular space formed with the casing (34) into the gas lift accelerator conduits. The GS style running tool (141) is released and retrieved. The upper tubing anchor lock (122) can be driven downhole by the GO style running tool (140) at the top of the gas lift accelerator assembly (1, 120), positioning it by any suitable depth correlation method. The upper tubing anchor lock (122) and the lower tubing anchor lock (123) may completely secure the position of the gas lift accelerator assembly (1, 120) avoiding displacement or damage during operation or from unintended impact with a downhole tool or tube put down into the well. The GO style running tool (140) is released and retrieved to surface. The depth of the installed upper tubing anchor lock (122) is verified by running a diagnostic tool, such as those used in fishing procedures like impression blocks or any other typical electronical tools. After conformity of depth, the gas lift accelerator tool is ready for operation by injecting the gas or power fluid downhole through the annular area, flowing into the gas lift accelerator inlet conduit though the aligned openings of the gas lift mandrel (35).

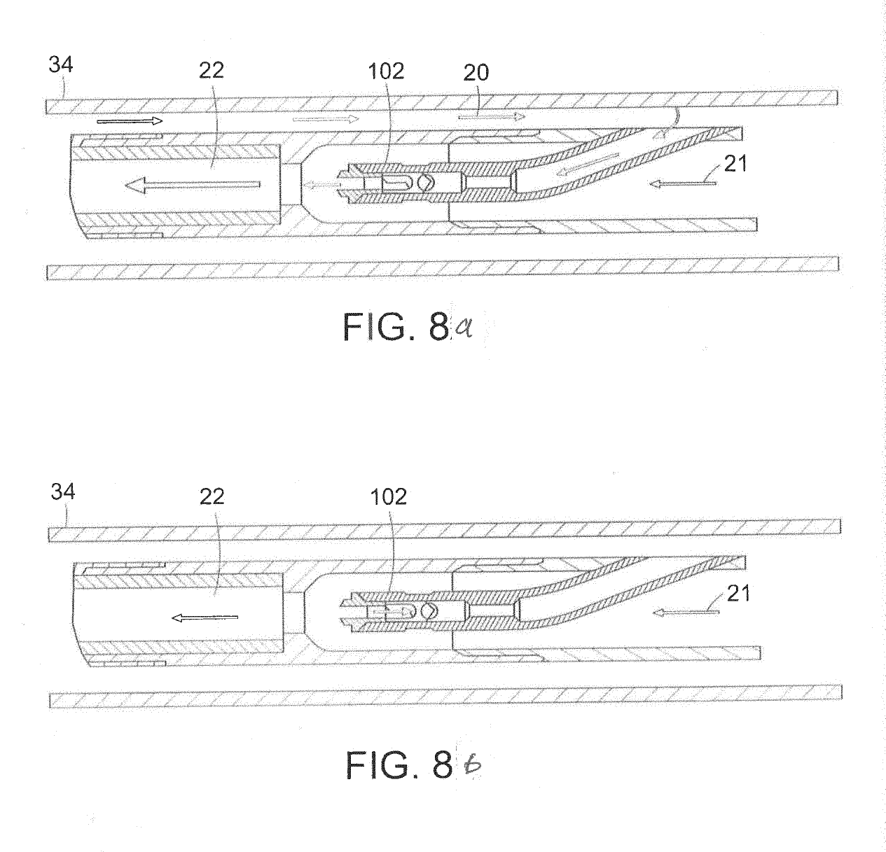

FIG. 8a and FIG. 8b show an exemplary embodiment for the check valve element (102) of the gas lift accelerator tool, represented by a spherical body, but not limited to other geometries used in sealing valve mechanisms, acting as a normally closed valve, with a spring like element but not limited to it, which pushes the spherical element against a settlement to avoid the passage of the reservoir fluid (21) when the pressure in the annular area between the tool and the casing (34) is lower than that of the reservoir fluid. FIG. 8a shows the case where injection fluid (20) pressure is greater than reservoir pressure and enters the device and opens the check valve to energize the Venturi. Well fluid (21) is drawn into the tool and mixes with the jet fluid in the Venturi throat. The mixed fluid (22) is then lifted to surface from the increased pressure resulting from the Venturi diffuser. FIG. 8b shows the case where pressure of injection fluid (20) is less than reservoir pressure or not present. Well fluid (21) drawn into the tool closes the check valve to block the open conduit to the surface equipment.

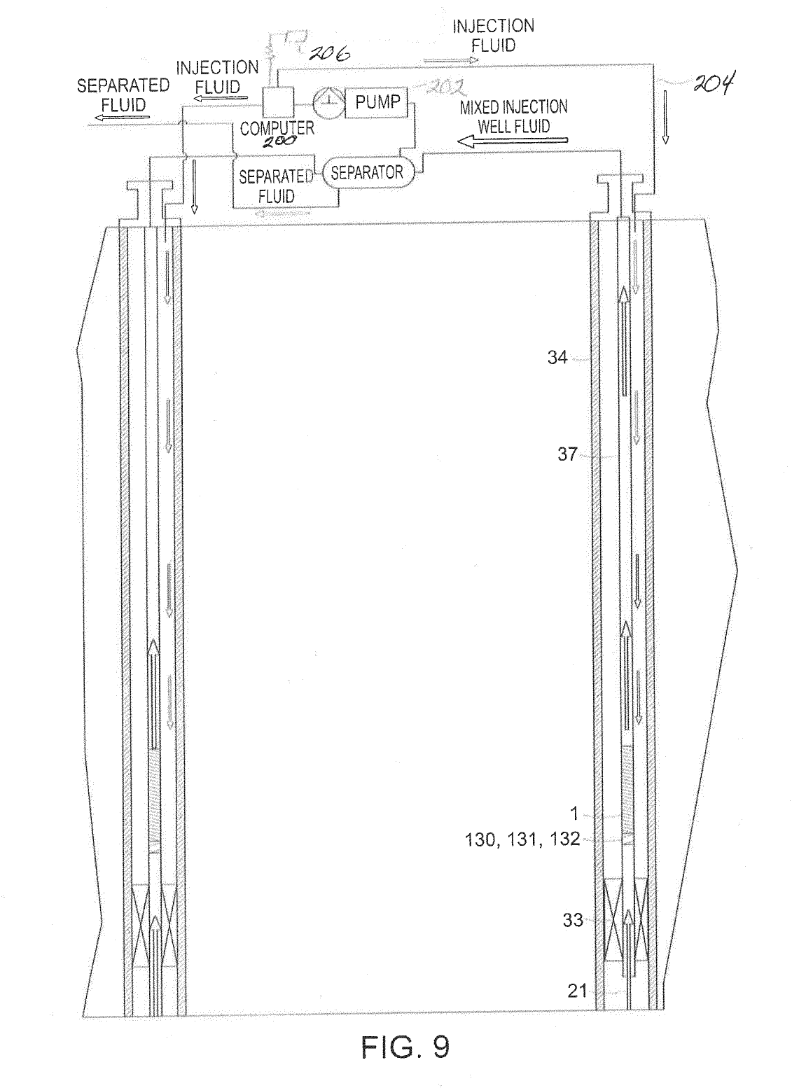

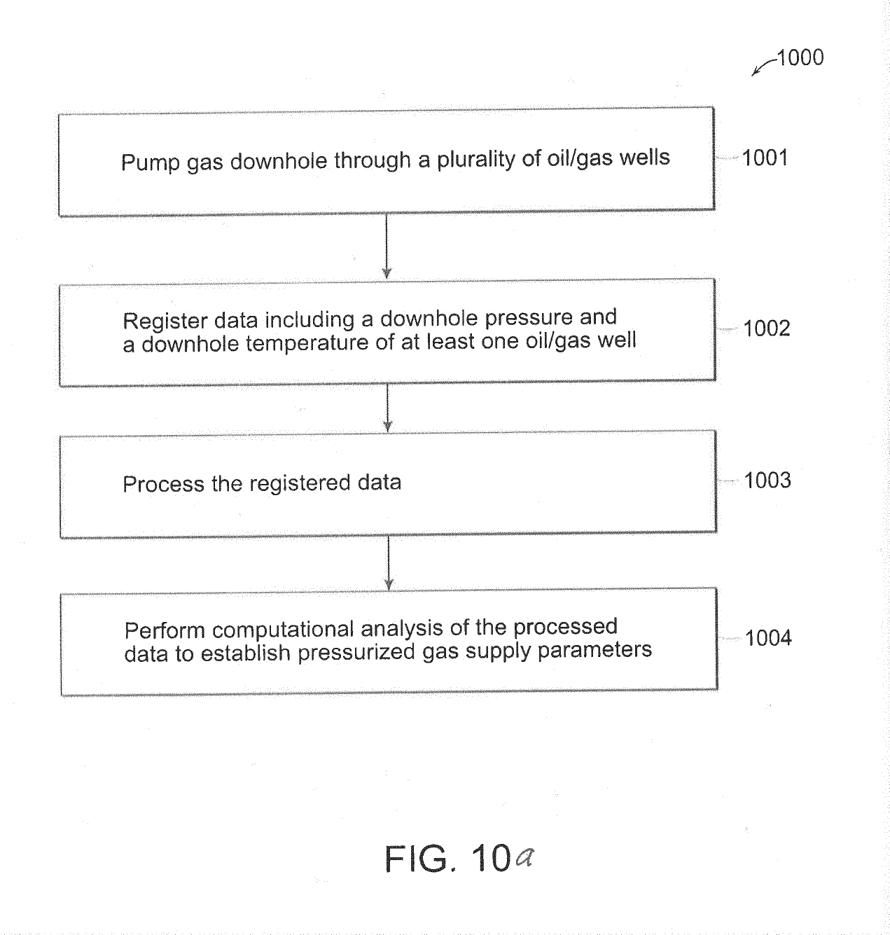

FIG. 9 is an schematic view of a plurality of producing oil/gas wells with a GLA bottom hole assembly (1) and a fluid sensor device or nipple (130) installed at the bottom of it, illustrating an exemplary embodiment of a gas lift accelerator method in which a common source of gas (20) or any other power fluid is pressurized and pumped downhole through the annular space formed between the casing 34 and the production tubing (37). The method can include registering the data of the pressure and temperature with the downhole sensors (131) located in the sensor nipple (130) sent by a communication element (132) and process it by surface data processing equipment, and run computational simulations and algorithms in order to establish the appropriate parameters of the pressurized gas (20) to be supplied to each well. The algorithms and simulations can allow optimization of the gas or power fluid resources used, use smaller surface compression resources and energy, which may be useful for oil fields with a large number of producing wells utilizing a gas lift accelerator recovery system, and allows dynamic adjustment of the operation of the gas lift accelerator tool according to variations on the reservoir fluid, to optimize the well production. The computer 200 can be electrically connected to the one or more sensors via wiring 204 extending into the well and processes the data to generate further control signals to the pump and other electrically actuated controls to adjust fluid pressure in the system. The computer 200 can include a display, one or more data processors, one or more memories and can be connected to a network for remote monitoring and control of the system using a remote computer 206 and data storage system.

Permeability defines the ability of a rock to allow flow through its interconnected pores. The Well core flow test is a method for determining the permeability of the formation and comparing potential damage due to the use of one or more fluids in a well. These tests are performed on a permeability test bank, which is an instrument that records flows and pressures as fluids pass through the rock cores to calculate permeability according to the Darcy's Law equation considering horizontal flow: Where the discharge q₀ for a particular system can be reflected in the following equation where K₀ is the permeability of the medium, Pₑ−P_{wfs} is the pressure drop, M₀ is the dynamic viscosity, and remaining terms defined by the geometry of the system (see generally M. King Hubbert (1957) Darcy's Law and the Field Equations of the Flow of Underground Fluids, Hydrological Sciences Journal, 2:1, 23-59, DOI: 10.1080/0262 6665709493062), the entire contents of which is incorporated herein by reference.

$${q}_{o} = \frac{7.08 \times {10}^{- 3} {K}_{0} h ( Pe - Pwfs )}{{μ}_{0} {B}_{0} ( ln ( \frac{{r}_{e}}{{r}_{w}} ) - 0.75 + S + aq )}$$

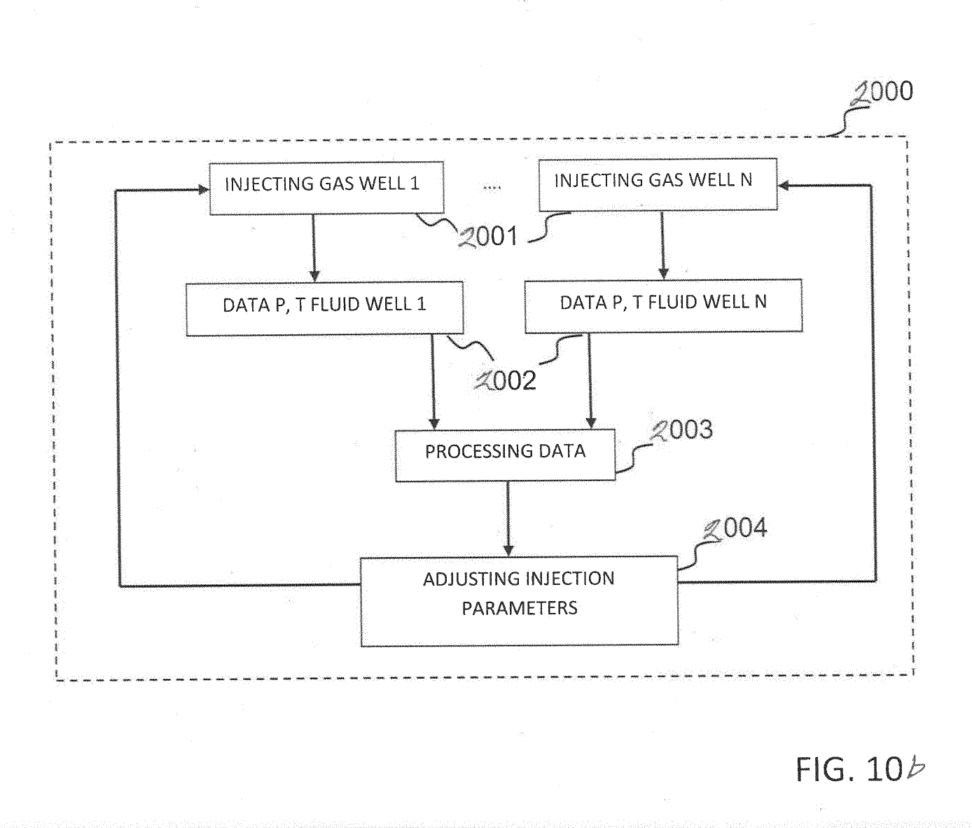

Referring now to FIG. 10a, a flow chart illustrating an exemplary embodiment of a method 1000 for operating an oil/gas well is provided. The method 1000 includes pumping gas 1001 downhole through a plurality of oil/gas wells. In some exemplary embodiments, the gas is pumped 1001 through an annular space formed between a casing 34 and a production tubing 37 of a GLA bottom hole assembly 1. The method 1000 further includes registering data 1002 including a downhole pressure and a downhill temperature of at least one of the oil/gas wells. In some exemplary embodiments, the data can be registered with downhole sensors 131 located in a sensor nipple or marker 130 installed in the GLA bottom hole assembly 1. The registered data is processed 1003 and computational analysis of the processed data is performed 1004 to establish pressurized gas supply parameters, which may be used to determine how the gas is pumped 1001 to one or more of the oil/gas wells. Exemplary pressurized gas supply parameters may include, but are not limited to, flow rate, temperature, and pressure of the supplied gas. In some exemplary embodiments, the data may be sent from the nipple 130 to data processing equipment at the surface by, for example, a communication element 132 in the nipple 130. In some exemplary embodiments, the method 1000 is run in a continuous loop to constantly monitor and, if needed, adjust the gas supply parameters to one or more of the oil/gas wells.

FIG. 10b illustrates a process 2000 in which computer 200 and/or remote server or data processor 206 processes 2003 measured data 2002 from a plurality of wells 1 . . . N to adjust injection parameters 2004 at each of the wells 2001. The data can include pressure and temperature measured by sensors in each of the well as described herein. The system provides feedback control of the parameters of the fluid injected into the well including temperature, pressure and flow rate.

Although the teachings herein have been described with reference to exemplary embodiments and implementations thereof, the disclosed systems are not limited to such exemplary embodiments/implementations. Rather, as will be readily apparent to persons skilled in the art from the description taught herein, the disclosed systems are susceptible to modifications, alterations and enhancements without departing from the spirit or scope hereof. Accordingly, all such modifications, alterations and enhancements within the scope hereof are encompassed herein.

What is claimed is:

1. A downhole gas lift accelerator apparatus for oil extraction in a well comprising
a jet pump module including a tubular mandrel housing which contains an internal Venturi throat and a Venturi diffuser and a Venturi nozzle, connecting a bottom side low pressure well fluid with an upper side energized mixture on the inside of a production conduit,
an inlet conduit connecting an annular space between an outside surface of the mandrel housing and a well case with the internal Venturi throat, to provide flow of a pressurized gas injected from a surface device through the annular space between the well case and an annular production tube, such gas being accelerated as it passes through the inlet conduit and the Venturi nozzle into the Venturi throat, thereby forming a pressure drop that produces a low pressure, high density well fluid located at the bottom of the jet pump to flow towards the Venturi throat such that an accelerated gas mixes with the well fluid to form the energized mixture at the Venturi diffuser,
a back flow restraint element that can move between a closed or an open position at an inlet gas pressure threshold,
at least one exchangeable interface element which attaches the jet pump module to the production tube and seals the passage for fluids between an apparatus inner side and an outer side, being located at the upper side of the jet pump module or at the lower side of the jet pump module or in both sides of the jet pump module relative to the production of the well.

2. The apparatus of claim 1 where the jet pump module with the inlet conduit and the back flow restraint element can be used in oil wells with different completion configuration by only replacing at least one of the exchangeable interface elements.

3. The apparatus of claim 2 where the exchangeable interface elements includes a fish neck retrieval sub to operate in wells with an installed gas lift mandrel on the production tube.

4. The apparatus of claim 2 wherein the exchangeable interface elements includes a tubing anchor lock to operate in a well with an installed sliding sleeve on the production tube.

5. The apparatus of claim 1 wherein the injected gas is accelerated to supersonic level when passing through the Venturi nozzle into the Venturi throat comprising a constrictor.

6. The apparatus of claim 1 wherein the inlet conduit, the Venturi throat, the Venturi diffuser and the Venturi nozzle of the jet pump module are made of carbon steel 4140 with tungsten.

7. The apparatus of claim 1 wherein the back flow restraint element can comprise a blocking element and a bias spring that can be adjusted according to the depth of operation, type of oil in the well and pressure of the oil.

8. The apparatus of claim 7 wherein the back flow restraint element is adjusted by variation of the spring element.

9. The apparatus of claim 1 wherein the back flow restraint element can be used as a gas lift control valve.

10. The apparatus of claim 1 wherein the well fluid flows up to the surface by the combined effect of the pressure increase of the gas/oil mixture, the lower density of the energized mixture respect to the oil itself and the pressure drop at the Venturi throat.

11. The apparatus of claim 1 further comprising a lower nipple containing pressure sensors, temperature sensors, and data transmitting elements attached to the lower side of the jet pump module.

12. The apparatus of claim 11 further comprising a surface data acquisition and processing unit receiving the data from the downhole sensors.

13. A method for extracting oil in a well by injecting gas from a surface device into a down hole gas lift accelerator apparatus comprising a jet pump module, an inlet conduit with a back flow restraint with a spring type element, a lower module with pressure and temperature sensor, a surface data processing equipment and supplementary oil operation device including a surface gas pressure station and a well service running tool, the method comprising the steps,
setting the downhole gas lift accelerator apparatus to one or more well conditions before delivery into a well bore;
verifying location of a downhole packer at a specified production depths;
lowering the downhole gas lift accelerator apparatus into the well down to the operating depth with the well service running tool and device;
locking the downhole gas lift accelerator apparatus to the production tubing or an element installed previously to the completed production tubing at the operating depth;
injecting the high pressure gas from the surface gas pumping station through the annular between the casing and the production conduit until reaching the operational pressure level over the opening of the back flow restrain element;
processing the data acquired from the well fluids with the downhole sensors and measurements on surface recovered mixture;
pumping the well fluids up to the surface; and
evaluating system performance and adjusting the gas pressure and flow.

14. The method according to claim 13 wherein the settings of the downhole gas lift accelerator apparatus comprises the replacement of the exchangeable interface element according to the type of completion of the well.

15. The method according to claim 13 wherein the settings of the downhole pumping apparatus comprises modifications to the spring element of the back fluid restrain to adjust it to the required pressure.

16. The method according to claim 13 wherein such service running tool and device can be a wire line equipment.

17. The method according to claim 13 wherein such service running tool and device can be a slickline system.

18. The method according to claim 13 wherein such service running tool and device can be a coil tubing system.

19. The method according to claim 13 wherein such service running tool can be a GS and GO style running tool.

20. The method according to claim 13 wherein the locking of the downhole gas lift accelerator apparatus to the production tubing may require successive trips of the service running tool to lock sequentially the interface elements of the apparatus to the production tubing or the completion elements of the well.

21. The method according to claim 13 wherein the operating depth can be greater than 10.000 feet.

22. The method according to claim 13 wherein the inlet conduit of the gas lift apparatus must be above the depth of the downhole packers.

23. The method according to claim 13 wherein the oil to be extracted is a heavy crude oil with API grade over 10.

24. The method according to claim 13 wherein the reservoir fluid to be extracted has no pressure to overcome the hydrostatic column to flow up to the surface.

25. A method to control the distribution of a gas into one or more oil producing wells with a gas lift accelerator apparatus comprising a jet pump module, an inlet conduit with a back flow restraint, a lower module with a pressure sensor and a temperature sensor, a data processing device and a surface gas pressure station, the method comprising the steps of:
evaluating well conditions to determine a gas pressure and flow rate for the one or more oil producing wells;
injecting pressurized gas at a preliminary pressure and flow level;
measuring pressure and temperature data in at least one well;
processing the data;
performing computational analysis of the processed data; and
correcting parameters of the gas pressure and flow rate.

26. The method of claim 25 wherein the surface gas pressure station comprises a pump that receives control signals from the data processing device.

27. The method of claim 25 further comprising controlling a temperature of the gas being injected into the at least one well.

28. The method of claim 25 further comprising accelerating fluid through a Venturi in the jet pump module.
